(19) United States
(12) Patent Application Publication
(10) Pub. No.: US 2008/0279077 A1
(43) Pub. Date: Nov. 13, 2008

(54) Apparatus for and a method of enabling copying a copy-protected recording medium

(75) Inventor: Ian Michael Lewis, Wallingford (GB)

Correspondence Address: PATENT DEPARTMENT;MACROVISION CORPORATION, 2830 DE LA CRUZ BLVD., SANTA CLARA, CA, 95050, US

(73) Assignee: Macrovision Corporation

(21) Appl. No.: 11/801,505

(22) Filed: May 9, 2007

(51) Int. Cl. G11B 7/28

(52) U.S. Cl. 369/84

(57) ABSTRACT

Apparatus and methods are described to inhibit automatic installation of software by an installer carried on a recording medium so as to enable copying of content data from the recording medium. When the recording medium is inserted into a reader, an inhibitor inhibits an installer carried upon the recording medium from installing a copy protector by mimicking prior installation of the copy protector.

### FIELD OF THE INVENTION

This invention relates to apparatus for and a method of enabling copying of a copy-protected recording medium, in particular a copy-protected recording medium such as an optical disc or other recording medium on which content data can be accessed in a non-sequential manner using navigational data stored by the recording medium. For simplicity, a recording medium such as an optical disc, its precursor, or other recording medium on which content data can be accessed in a non-sequential manner using navigational data stored by the recording medium is referred to hereinafter simply as a “recording medium”.

### BACKGROUND OF THE INVENTION

The advent of digital recording techniques has enabled digital copies of digital content carried by recording media such as optical discs (for example DVDs) to be made with little or no loss of copy quality. This makes it easy for an unauthorised person to produce unauthorised copies of digital content-carrying recording media. Accordingly, copy-protection techniques have been developed.

One technique for providing copy-protection is to provide copy protection software on the recording medium so that, when the recording medium is first accessed by a reader, the copy-protection software is automatically installed in the reader before the reader is able to access the content data carried by the recording medium.

Where the reader comprises a computing apparatus such as a personal computer or the like having recording medium reading functionality or coupled to a recording medium reader, then the automatic installation of copy-protection software may be achieved by taking advantage of facilities provided by the computing apparatus' operating system to execute computer programs automatically. Examples of such facilities include the autorun feature of Microsoft's Windows (Registered Trade Mark) operating systems and the autostart feature of Apple's MAC (Registered Trade Mark) operating systems. Such facilities typically work by, when a recording medium is inserted into an appropriate drive, looking on the recording medium for a specifically named configuration or executable file. An operating system may use polling to check for the insertion of a recording medium, alternatively, interrupts may be employed. For example, in the Windows operating system when the operating system disk change notification polling discovers a newly introduced recording medium, Windows checks in the new recording medium's root directory for the existence of an autorun.inf configuration file. If an autorun.inf file is found, Windows reads and follows the specific instructions of that file. Such instructions may tell Windows which executable to start, which icon to use, and which additional menu commands to make available.

Accordingly, one way of ensuring automatic installation of copy protection software on a reader is to include instructions in or associated with a specifically named configuration or executable file accessed by the operating system when the recording medium is first inserted into the appropriate drive to cause automatic installation of the copy-protection software, including installation of appropriate drivers (which may be kernel-mode drivers or otherwise) and creation of appropriate symbolic links, if that or the current version of that copy protection software is not already installed. Once installed in a reader, the copy-protection software acts to inhibit copying of any recording media carrying an indicator (for example a copy-protection flag) that indicates that copying of the content data carried by that recording medium is prohibited.

Although the inhibition of content copying is generally desirable, there may be situations in which a user has a legitimate reason for copying the content of a recording medium. Such situations may occur when, for example, the master copy of the content has been lost or damaged and content needs to be reclaimed from the recording medium. Alternatively, a user may have been given permission by the copyright owner to copy the content for a specific purpose. In such cases it is desirable to provide the user with methods and apparatus to circumvent the copy-protection to enable copying of the content of a recording medium.

### SUMMARY OF THE INVENTION

In a first aspect, the present invention provides apparatus for and a method of inhibiting automatic activation of copy-protection of a recording medium.

An embodiment provides apparatus for enabling copying of content data from a recording medium that carries an installer to automatically activate a copy protector when the recording medium is inserted into a reader, the apparatus comprising of an inhibitor operable to inhibit the installer from installing the copy protector.

According to a second aspect of the present invention, there is provided apparatus for and a method of inhibiting installation of software by an installer carried by a recording medium when the recording medium is inserted into a reader.

In an embodiment, there is provided apparatus for inhibiting automatic installation of software by an installer carried by a recording medium when the recording medium is inserted into a reader, the apparatus comprising an inhibitor to mimic prior installation of the software.

The recording medium may be an optical disc such as a DVD or a precursor thereof such as Digital Linear Tape, glass master, or stamping master, or may be any other form of recording medium from which content data can be accessed in a non-sequential manner using navigational data stored on the recording medium. Example recording media include: CDs, CDROMs, CD-Rs, DVDs, and DVD±RWs.

### BRIEF DESCRIPTION OF THE DRAWINGS

Embodiments of the present invention will now be described, by way of example, with reference to the accompanying drawings, in which:

FIG. 1 shows a functional block diagram of copying apparatus for copying a copy-protected recorded optical disc such as a DVD;

FIG. 2 shows a functional block diagram of computing apparatus that may be programmed by program instructions to provide copying apparatus such as that shown in FIG. 1;

FIG. 3 shows a diagram illustrating an example of computing apparatus that may be programmed to have the functionality of the copying apparatus shown in FIG. 1;

FIG. 4a shows a very representational diagram for explaining the content of a copy-protected DVD;

FIG. 4b shows a very representational diagram of an DVD illustrating some recorded sectors; and

FIG. 5 is a flow chart for explaining operations carried out by the copying apparatus.

### DETAILED DESCRIPTION OF THE INVENTION

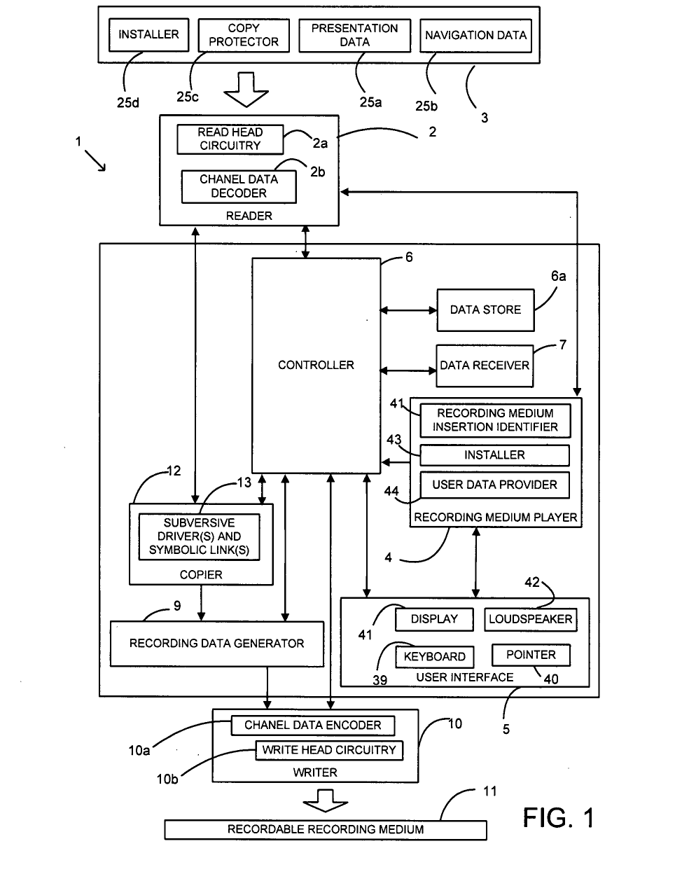

Referring now to FIG. 1, a copying apparatus 1 has a reader 2 operable to read a recording medium 3 such as an optical disc, in this case a Digital Versatile Video Disc (DVD-Video) which, as shown in FIG. 1, carries presentation data 25a (that is the audio and video content data to be delivered to a viewer by a DVD player), navigation data 25b (comprising general control data, search control data, user interface control data, and navigation control data) to enable navigation through the content of the disc 3 in a non-sequential manner in accordance with the appropriate DVD standard, copy protector data 25c to inhibit copying of content data from the recording medium, and installer data 25d to install copy protection software upon copying apparatus 1.

The copying apparatus 1 is configured to function, under the control of a controller 6, as a conventional recording medium, in this case a DVD, player and so has a reader 2 to receive a recording medium and to read sectors of data from a recording medium, and a recording medium player 4 to play the content data to a user via a user interface 5 by navigating through the recording medium in accordance with navigation data read from the recording medium by the reader and user instructions input via the user interface 5.

As shown in FIG. 1, the reader has read head circuitry 2a operable to read sectors of data from a recording medium 3 and a channel data decoder 2b operable to decode channel data read by the read head circuitry 2a. Although not shown in FIG. 1, as is conventional, the channel data decoder 2b comprises a clock extractor for extracting a clock signal, a de-interleaver or de-shuffler for de-shuffling sectors, and a channel decoder for decoding the channel data.

The user interface 5 has a display 41 and one or more loudspeakers 42, and a user input device which may comprise at least one of a keyboard 39 and a pointer 40, which may be a remote control or a computer pointing device such as a mouse.

The recording medium player 4 has a recording medium insertion identifier 41 which, in conventional operation, polls the reader (or receives interrupts signals from the reader) to determine when a recording medium has just been received in the reader, an installer 43 to install software and/or data read from a recording medium on the copying apparatus, for example in a data store 6a within or associated with the controller 6, and a user presentation data provider 44 to demultiplex and decode content data read from a recording medium in accordance with the standard under which the recording medium was recorded (for example as set out in the DVD standards specifications) and to supply the user presentation data to the user interface 5 to enable the user to watch and/or listen to the content data.

The copying apparatus may have a data receiver 7, for example a video data receiver, to receive video data generated by the user, for example downloaded from a digital video camera. The copying apparatus 1 has a recording data generator 9 to assemble the content data to be recorded onto a recording medium and to add, if required by the user, navigation data under the control of the controller 6 and the user (via the user interface 5). The recording data generator 9 may comprise authoring software and facilities to encode and multiplex audio and video data in accordance with the standard under which a recording medium is being produced.

The copying apparatus 1 has a writer 10 to record or write assembled presentation data onto a recordable recording medium 11. The writer 10 has a channel data encoder 10a and write head circuitry 10b for writing sectors of data onto a recording medium 11. Although not shown in FIG. 1, as is conventional, the channel data encoder 10a comprises a channel data coder having an interleaver, and a channel encoder for carrying out the conventional DVD channel encoding operations to produce channel code data to be written onto a recordable recording medium by the write head circuitry 10. In this example, the recordable recording medium 11 is a recordable DVD. As another possibility, the recordable recording medium may be a digital linear tape or other suitable storage medium for supply to a replicate that is configured to produce a glass master, subsequent stamping masters, and then to press multiple copies from the stamping masters.

The controller 6 controls overall operation of the copying apparatus 1 and communicates with the reader 2, the player 4, the recording data generator 9, the data receiver 7 (if present), the writer 10 and the user interface 5. The user interface 5 enables a user to communicate with the copying apparatus, for example as shown via the controller 6, so as to control operations of the copying apparatus and so as to be supplied with information by the controller 6.

As described so far, the copying apparatus is capable of reading and playing a recording medium such as a DVD and also of producing a recording medium such as a DVD from data received by the data receiver 7 or otherwise supplied by a user.

The copying apparatus 1 also has a copier 12 to copy an already-recorded recording medium. The copier 12 is configured, under control of the controller 6, to control the reader 2 to read sectors of data from a recorded recording medium and to cause the recording data generator 9 to assemble the read sectors of data for record al by the writer 10 onto a recordable recording medium 11 which may in this example be a DVD or DOLT. The copier 12 may be, for example, a file-by-file ripper which copies the recording medium sector by sector or an INFO parsing ripper which parsing the information data carried by the recording medium to determine which sectors to copy. The copier 12 has one or more subversive driver(s) and subversive symbolic link(s) 13 that, as will be explained in greater detail below, prevent or at least inhibit the installer 43 from installing copy-protection software of a copy-protected recording medium.

FIG. 1 shows the reader 2 and the recording data generator 9 as part of the copying apparatus. However either one of or both of the reader and the recording data generator 9 may be a separate physical entity coupled to the copying apparatus by at least one of a direct wired connection, a direct wireless connection, an indirect wired connection and an indirect wireless connection, where an indirect connection may be via a network. Similarly, the writer 10 may be part of the copying apparatus (as a separate entity or as part of the recording data generator 9, for example) or may, as shown in FIG. 1, be a separate physical entity coupled to the copying apparatus by at least one of a direct wired connection, a direct wireless connection, an indirect wired connection and an indirect wireless connection, where an indirect connection may be via a network.

It will of course be appreciated that the functional components shown in FIG. 1 simply illustrate the functionality provided by the copying apparatus and that FIG. 1 should not be taken to imply that these functional components exist as discrete physical entities. Rather, the functionality may be provided by one or more physical components and, in the latter case, the functionality provided by a single functional component shown in FIG. 1 may be distributed between different physical components. In addition, different aspects of the functionality may not be separately identifiable. Also, the copying apparatus need not necessarily have a separate controller, its functionality may be distributed between the other functional components of the copying apparatus.

The functional components shown in FIG. 1 may, as appropriate, be provided by hardware, firmware, software or any combination of these.

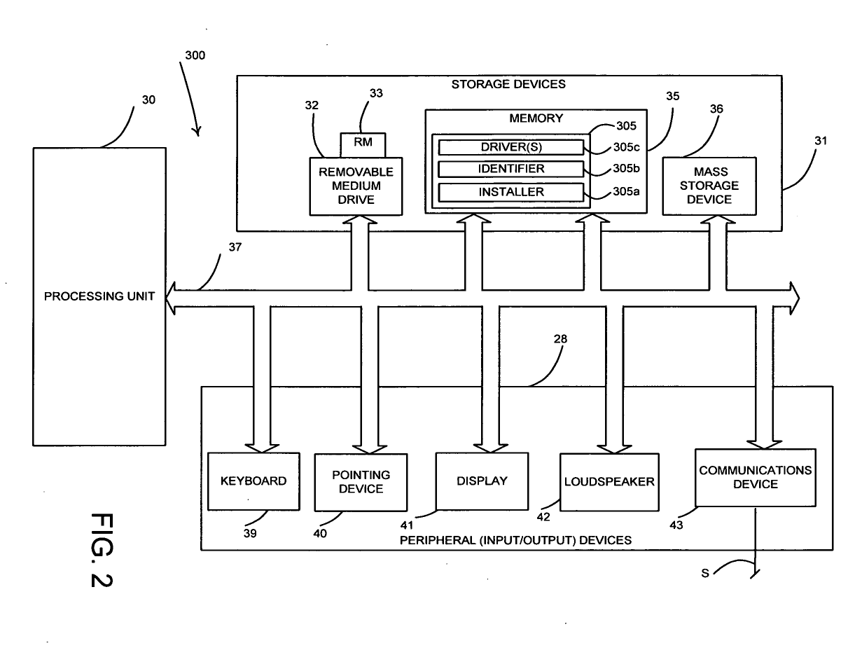

FIG. 2 shows a functional block diagram of computing apparatus 300 that may be programmed by program instructions to provide copying apparatus such as that shown in FIG. 1.

The computing apparatus 300 comprises a processing unit 30 coupled by one or more buses 37 to storage devices 31 which may comprise a removable medium drive 32 to receive a removable medium ARM 33 (in this. Case a DVD drive to receive a DVD and/or a DOLT drive), internal memory 35 such as read only memory (ROM) and/or random access memory (RAM) and a mass storage device 36 such as a hard disc drive.

The bus 37 also couples the processing unit 30 to a number of peripheral input/output devices that may form the user interface 5 shown in FIG. 1, in this case the keyboard 39, pointer device 40, display 41 and loudspeaker(s) 42. The peripheral devices may also include a communications device 43 to provide network communication. The communications device 43 may be, for example, a MODEM, network card or the like to enable the computing apparatus 300 to communicate over a network such as any one or more of the Internet, an intra net, a local area network, wide area network or any other suitable form of network.

It will, of course, be appreciated that the storage devices and input/output devices may not comprise all of those shown in FIG. 1 and/or could comprise additional devices. For example, one or more further removable medium drives, such as a floppy disc drive, may be provided and other input/output devices such as a microphone and a USB or other port may be provided.

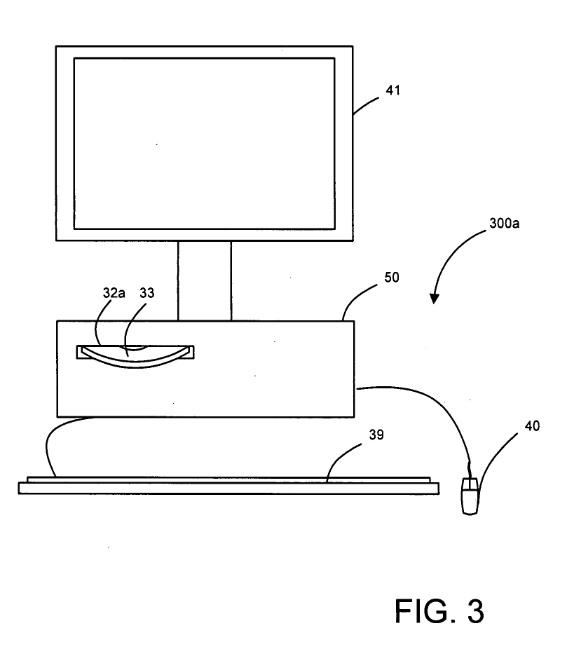

As shown diagrammatically in FIG. 3, the computing apparatus may be a personal computer or server 300a which has a main processor unit 50 containing the processing unit 30 and storage devices 31 and user interface devices in the form, as shown, of the keyboard 39, a mouse forming the pointing device 40 and the display 41. FIG. 3 shows a removable medium 33 (such as a DVD or DOLT) being ejected from an insertion slot 32a of a removable medium drive 32.

The computing apparatus 300 or 300a may be programmed to provide the copying apparatus shown in FIG. 1 by program instructions and/or data supplied by any one or more of the following routes:

Pre-stored by ROM and/or a mass storage device;
Input by a user using an input device such as the keyboard 39 and/or the pointing device 40 downloaded from a removable medium 33 received by the removable medium drive 32; and supplied as a signal S via the communications device 43.

In this example, the program instructions to provide the copying apparatus include program instructions 305 to enable reading of a recording medium such as a DVD and also to inhibit the operation of a copy-protector carried by such a recording medium. As illustrated in FIG. 2, the program instructions 305 are stored in memory 35 and comprise: an installer 305a to install one or more subversive drivers and create one or more associated subversive symbolic links 305c on computing apparatus 300 or 300a; and an identifier 305b to identify when a copy-protected recording medium has been inserted into the removable medium drive 32.

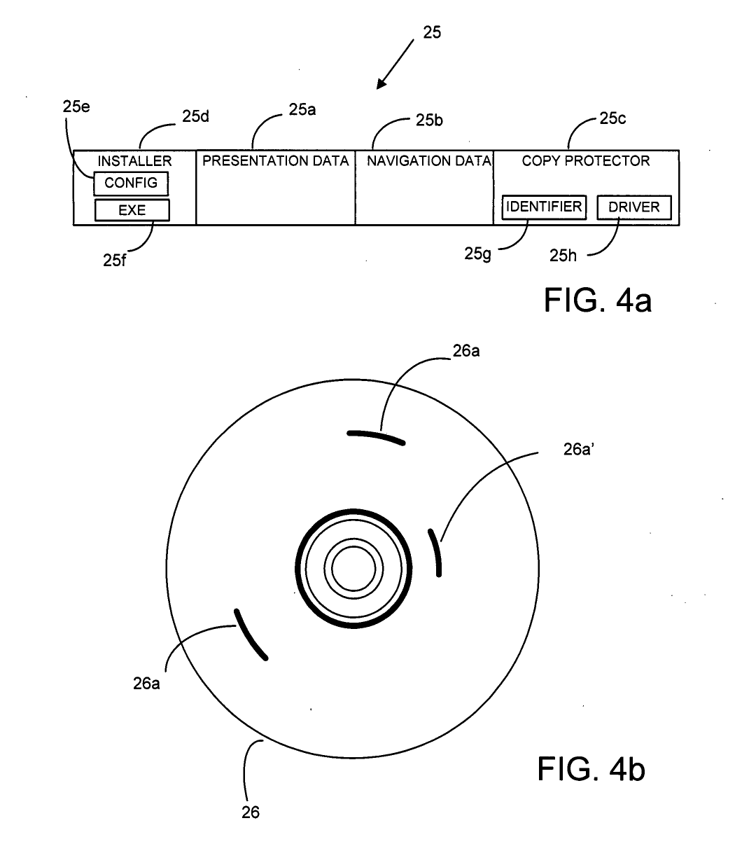

FIG. 4a shows a very representational diagram to illustrate the data carried by a copy-protected recording medium which may be the recording medium 3 shown in FIG. 1 or the recording medium 33 shown in FIG. 3. As shown schematically in FIG. 4a, the recording medium carries data 25 including: presentation data 25a; navigation data 25b; copy protection data providing a copy protector 25c which includes an identifier 25g to identify that the recording medium 26 is copy protected, and a legitimate driver 25h to be installed on a copying apparatus 300 or 300a as shown in FIGS. 2 and 3; and an installer 25d to cause installation of the legitimate driver 25h when the copy-protected recording medium is inserted a removable medium drive 32 of a reader, such as the reader 2 shown in FIG. 1. Installer 25d comprises an executable program 25f to install the legitimate driver 25h which creates a legitimate symbolic link upon computing apparatus 300 or 300a. One skilled in the art will appreciate that there are other ways of implementing the installer 25d. Thus as another possibility, the recording medium may carry a registry file that is used to install a legitimate driver 25h. The registry file contains data to be added to the registry (not shown) of the computing apparatus 300 or 300a and the location at which this data should be placed in the registry. As yet another possibility, the executable program 25f may install a legitimate driver 25h by editing the register directly and updating it with information corresponding to that which would be provided by a registry file.

FIG. 4b shows a very representational plan view of a recording medium 26, in this case a DVD, having sectors 26a in which the data shown in FIG. 4a are stored.

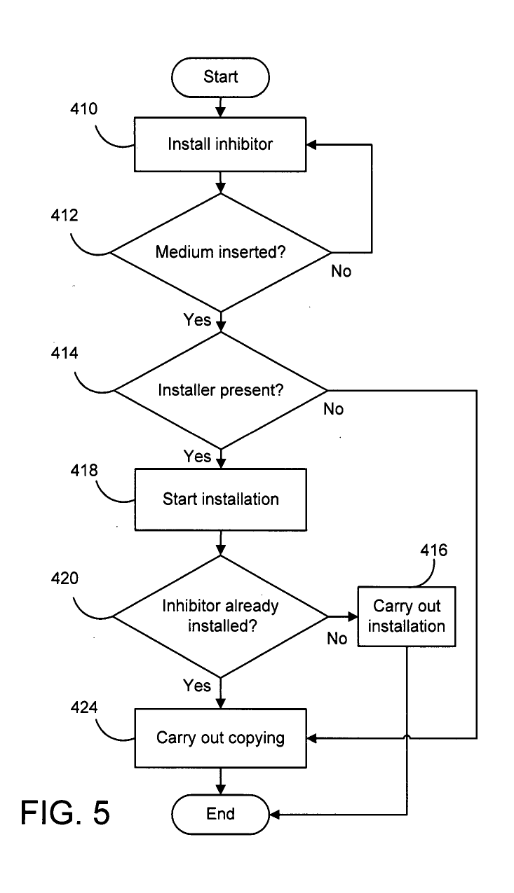

FIG. 5 illustrates operations carried out by the copying apparatus shown in FIG. 1.

At 410 a user installs an inhibitor by installing a subversive driver which creates a subversive symbolic link. At least one of the subversive driver and the subversive symbolic link has the same name as the corresponding legitimate driver or legitimate symbolic link. The subversive driver or subversive symbolic link may of course already be installed or created.

At 412, the copying apparatus waits for a recording medium to be inserted into the removable medium drive 32. When, a recording medium is inserted into the removable medium drive 32, the reader is caused by the received recording medium to access any copy protection installer 25d carried by the recording medium. For example, when the recording medium and the copying apparatus operate with the Windows operating system, upon notification of insertion of the recording medium, the Windows operating system searches the recording medium for an autorun.inf file which will cause the operating system to access and install any copy protection installer 25d. In this example, the configuration file 25e is a text file that is parsed by the operating system to determine which other executable file to execute. In this example, the installer 25d provides an executable program 25f which installs the copy protection driver.

If the received removable medium is not copy-protected and the copy-protector installer 25d is not present, then the copier 12 of the copying apparatus proceeds in accordance with the user's instructions to carry out the copying operation at 424.

If however the copy-protector installer 25d is present, then at 418 the installer tries to install the copy protector. Thus, in this example, the configuration file 25e causes the copying apparatus 1 to run the executable program 25f to cause the copying apparatus to install the legitimate driver(s) and to create the legitimate symbolic link(s), if not already present. If the installation of the copy protector is not inhibited by the prior installation of an inhibitor, the copy-protector is installed at 416 and will operate normally. However, if an inhibitor is already present, the executable program 25f is inhibited from providing the legitimate driver(s) and legitimate symbolic link(s). The copy protector is therefore not activated and the copier 12 of the copying apparatus can proceed, in accordance with user's instructions, to copy content from the recording medium at 424.

As another possibility, the executable program 25f may be configured to provide legitimate driver(s) and/or legitimate symbolic link(s) without checking to see whether drivers or symbolic links with the same names are already present. The copying apparatus will however give priority to the first provided driver or symbolic link, and so the prior provision of the subversive driver and subversive symbolic link 13 will inhibit operation of the copy-protector 25c.

In the embodiment described above, automatic installation of a copy protector from a recording medium is inhibited by the presence of a subversive driver or drivers of the same name and/or subversive symbolic link or links of the same name. The present invention may have applications in other areas, for example the general computing area. Thus, although automatic execution of software upon insertion of a recording medium may assist a user by, for example, avoiding the need for the user to identify a start up program or file carried by the recording medium and may also enable the producer of the recording medium to control how the user accesses the content data, it can have disadvantages. For example, because automatically executed programs do not require manual consent before they are executed, they may provide a mechanism for virus writers to get their code executed. For this and other reasons (for example to avoid software conflicts) a user may wish to control what content data/software data is installed onto their computer. Embodiments of the present invention may enable automatic inhibition of certain types of automatically executed programs other than copy protector installers by pre-installing subversive drivers and/or pre-creating subversive symbolic links having the same name as the drivers or symbolic links of the software whose automatic execution or installation is to be inhibited.

For the purposes of this specification, the terms software and computer code encompass not only executable program code, but also data or configuration files that may be accessed by executable code. Furthermore the terms executable, executable code, and executable program encompass not only an individual piece of computer code, but also elements that may be executed, called, scripted, parsed or invoked by a program.

Whilst certain combinations of features have been identified in the accompanying claims, the scope of the present invention is not limited to those combinations and instead extends to encompass any combination of features herein described irrespective of whether or not that particular combination has been explicitly enumerated.

What is claimed is:

1. Apparatus for enabling copying of content data from a recording medium that carries an installer to automatically activate a copy protector when the recording medium is inserted into a reader, the apparatus comprising an inhibitor operable to inhibit the installer from installing the copy protector.

2. Apparatus according to claim 1, wherein the inhibitor is operable to mimic prior installation of the copy protector.

3. Apparatus according to claim 1, wherein the inhibitor provides a subversive file having the same name as a file of the copy protector.

4. Apparatus according to claim 1, wherein the inhibitor provides a subversive driver or symbolic link having the same name as a driver or symbolic link of the copy protector.

5. Apparatus according to claim 1, wherein the copy protector is carried by the recording medium.

6. Apparatus according to claim 1, wherein the recording medium is selected from the group consisting of an optical disc, an optical disc precursor, a DVD, a CD-ROM, and a CD.

7. Apparatus according to claim 1, further comprising a copier operable to copy content data from the recording medium once installation by the installer has been inhibited.

8. A method of inhibiting automatic installation of software by an installer carried by a recording medium when the recording medium is inserted into a reader, the method comprising providing an inhibitor to mimic prior installation of the software.

9. A method according to claim 8, wherein providing the installer comprises providing at least one subversive file having the same name as a corresponding file of the software.

10. A method according to claim 8, wherein providing the installer comprises providing a subversive driver or symbolic link having the same name as a driver or symbolic link of the software.

11. A method according to claim 8, wherein the software comprises copy protection to inhibit copying of content data from the recording medium.

12. A method according to claim 11, wherein the copy protector is carried by the recording medium.

13. A method according to claim 8, wherein the recording medium is selected from the group consisting of an optical disc, an optical disc precursor, a DVD, a CD-ROM, and a CD.

14. A method according to claim 8, further comprising copying content data from the recording medium once installation has been inhibited.

15. A computer-readable medium comprising computer-implement able instructions to install an inhibitor to inhibit the installation of software by an installer carried by a recording medium by mimicking prior installation of the software.
